(19) United States
(12) Patent Application Publication
(10) Pub. No.: US 2010/0088632 A1
(43) Pub. Date: Apr. 8, 2010

(54) METHOD AND HANDHELD ELECTRONIC DEVICE HAVING DUAL MODE TOUCHSCREEN-BASED NAVIGATION

(75) Inventors: Michael KNOWLES, Waterloo (CA); David Paul YACH, Waterloo (CA)

Correspondence Address: Ridout & Maybee LLP, 225 King Street West, 10th Floor, Toronto, ON, M5V 3M2, CA

(73) Assignee: RESEARCH IN MOTION LIMITED, Waterloo (CA)

(21) Appl. No.: 12/534,982

(22) Filed: Aug. 4, 2009

Related U.S. Application Data
(60) Provisional application No. 61/103,894, filed on Oct. 8, 2008.

(51) Int. Cl. G06F 3/048; G06F 3/033

(52) U.S. Cl. 715/784; 345/157; 345/173; 715/856

(57) ABSTRACT

A method and touchscreen-based handheld electronic device having dual navigation modes are provided. In accordance with one embodiment, there is provided a handheld electronic device, comprising: a controller; a touchscreen display connected to the controller; the controller being configured for displaying on the touchscreen display a graphical user interface (GUI) having a display area defined by a boundary; and the controller being configured for providing a cursor navigation mode and a pan navigation mode, and for switching between the cursor navigation mode and the pan navigation mode in response to respective input.

### RELATED APPLICATION DATA

This present application claims priority to provisional U.S. patent application No. 61/103,894, filed Oct. 8, 2008, the content of which is incorporated by reference herein.

### TECHNICAL FIELD

The present disclosure relates generally to navigation mechanisms for touchscreen displays, and more particularly to a method and handheld electronic device having dual mode touchscreen-based navigation.

### BACKGROUND

Handheld electronic devices having a touchscreen display typically provide a mechanism for navigating through user interface screens using touch inputs on the touchscreen display. Some touchscreen-based navigation mechanisms may be more suitable for some types of user interface screens than other touchscreen-based navigation mechanisms. However, the touchscreen-based navigation mechanism is often fixed for particular handheld electronic devices, or fixed for particular operational modes or applications of the handheld electronic device. Thus, there remains a need for improved mechanisms for navigating through user interface screens on a touchscreen display.

### BRIEF DESCRIPTION OF THE DRAWINGS

FIG. 1 is a block diagram illustrating a communication system including a mobile communication device to which example embodiments of the present disclosure can be applied;

FIG. 2 is a block diagram illustrating a mobile communication device in accordance with one embodiment of the present disclosure;

FIG. 3 is a front view of the mobile communication device of FIG. 2 in accordance with one embodiment of the present disclosure;

FIG. 4 is a simplified sectional view of the mobile communication device of FIG. 2 with the switch shown in a rest position;

FIG. 5 illustrates a Cartesian dimensional coordinate system of a touchscreen which map locations of touch signals in accordance with one embodiment of the present disclosure;

FIG. 6A is a screen shot of a user interface screen of a pan navigation mode of a handheld electronic device in accordance with one example embodiment of the present disclosure;

FIG. 6B is a screen shot of a user interface screen illustrating a cursor navigation mode of a handheld electronic device in accordance with one example embodiment of the present disclosure;

FIG. 7 is a flowchart illustrating an example process for a pan navigation mode in accordance with one example embodiment of the present disclosure;

FIG. 8 is a flowchart illustrating an example process for cursor navigation mode in accordance with one example embodiment of the present disclosure; and

FIG. 9 is a flowchart illustrating an example process for switching between navigational modes of a handheld electronic device in accordance with one example embodiment of the present disclosure.

Like reference numerals are used in the drawings to denote like elements and features.

### DETAILED DESCRIPTION OF EXAMPLE EMBODIMENTS

The embodiments described herein generally relate to portable electronic devices, but could be applied outside of the portable electronic device field to desktop computers, point-of-sale systems such as retail or restaurant ordering systems, automated teller machines (ATMs) and other electronic kiosks, as well as other “fixed” touchscreen applications such as in industrial machinery. Examples of portable electronic devices include mobile (wireless) communication devices such as pagers, cellular phones, Global Positioning System (GPS) navigation devices and other satellite navigation devices, smartphones, wireless organizers, personal digital assistants and wireless-enabled notebook computers. At least some of these portable electronic devices may be handheld electronic devices. The portable electronic device may be a portable electronic device without wireless communication capabilities such as a handheld electronic game device, digital photograph album, digital camera and video recorder such as a camcorder. The portable electronic devices could have a touchscreen display as well as a mechanical keyboard. These examples are intended to be non-limiting.

The present disclosure provides a method and touchscreen-based handheld electronic device having a graphical user interface (GUI) having dual navigation modes, in particular a pan navigation mode and cursor navigation mode. The present disclosure also provides an efficient mechanism for switching between the pan navigation mode and cursor navigation mode.

In accordance with one embodiment of the present disclosure, there is provided a handheld electronic device, comprising: a controller; a touchscreen display connected to the controller; the controller being configured for displaying on the touchscreen display a GUI having a display area defined by a boundary; and the controller being configured for providing a cursor navigation mode and a pan navigation mode, and switching between the cursor navigation mode and the pan navigation mode in response to respective input.

In accordance with another embodiment of the present disclosure, there is provided a method of controlling a handheld electronic device comprising a touchscreen display, the method comprising: providing on the touchscreen display a graphical user interface (GUI) having an area defined by a boundary for displaying content, the GUI having a cursor navigation mode and a pan navigation mode; in the pan navigation mode: detecting touch events having a touchpoint on the touchscreen display; determining when the touchpoint of a touch event has changed; determining a change in location of the touchpoint relative to the screen orientation of the GUI; and scrolling the content in the area defined by the boundary in accordance with the change in location of the touchpoint; in a cursor navigation mode: detecting touch events having a touchpoint on the touchscreen display; determining when the touchpoint of a touch event has changed; determining a change in location of the touchpoint relative to the screen orientation of the GUI; and scrolling the content in the area defined by the boundary in accordance with the change in location of the touchpoint when the touchpoint has moved from a location within the area defined by the boundary to a new location outside of the area defined by the boundary; and switching between the pan navigation mode and cursor navigation mode in response to respective input.

In accordance with another embodiment of the present disclosure, there is provided a handheld electronic device, comprising: a controller; a touchscreen display connected to the controller; the controller being configured for displaying on the touchscreen display a graphical user interface (GUI) having an area defined by a boundary; the controller, in a pan navigation mode, being configured for: detecting touch events having a touchpoint on the touchscreen display; determining when the touchpoint of a touch event has changed; determining a change in the location of the touchpoint relative to the screen orientation of the GUI; and scrolling the content in the area defined by the boundary in accordance with the change in location of the touchpoint; the controller, in a cursor navigation mode, being configured for: detecting touch events having a touchpoint on the touchscreen display; determining when the touchpoint of a touch event has changed; determining a change in the location of the touchpoint relative to the screen orientation of the GUI; and scrolling the content in the area defined by the boundary in accordance with the change in location of the touchpoint when the touchpoint has moved from a location within the area defined by the boundary to a new location outside of the area defined by the boundary; the controller being configured for switch between the pan navigation mode and the cursor navigation mode in response to respective input.

In accordance with a further embodiment of the present disclosure, there is provided a computer program product comprising a computer readable medium having stored thereon computer program instructions for implementing a method on a handheld electronic device for controlling its process, the computer executable instructions comprising instructions for performing the method(s) set forth herein.

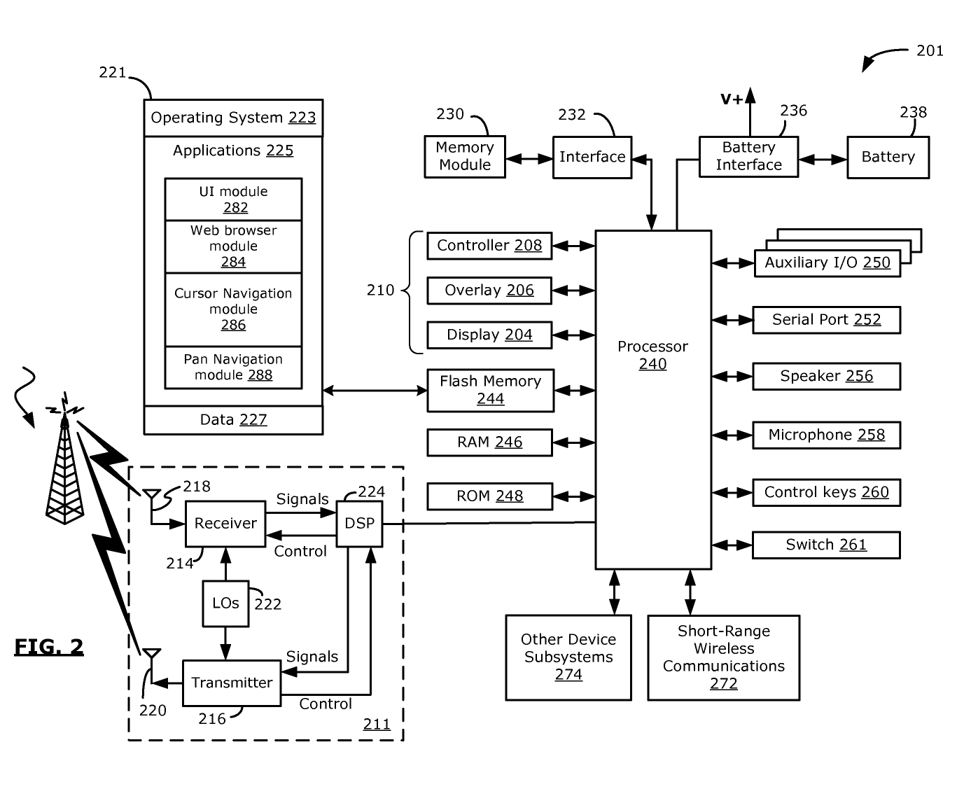

Reference is now made to FIGS. 2 to 4 which illustrate a mobile communication device 201 in which example embodiments described in the present disclosure can be applied. The mobile communication device 201 is a two-way communication device having at least data and possibly also voice communication capabilities, and the capability to communicate with other computer systems, for example, via the Internet. Depending on the functionality provided by the mobile communication device 201, in various embodiments the device may be a data communication device, a multiple-mode communication device configured for both data and voice communication, a smartphone, a mobile telephone or a PDA (personal digital assistant) enabled for wireless communication, or a computer system with a wireless modem.

The mobile communication device 201 includes a controller comprising at least one processor 240 such as a microprocessor which controls the overall process of the mobile communication device 201, and a wireless communication subsystem 211 for exchanging radio frequency signals with the wireless network 101. The processor 240 interacts with the communication subsystem 211 which performs communication functions. The processor 240 interacts with additional device subsystems including a display (screen) 204, such as a liquid crystal display (LCD) screen, with a touch-sensitive input surface or overlay 206 connected to an electronic controller 208 that together make up a touchscreen display 210. The touch-sensitive overlay 206 and the electronic controller 208 provide a touch-sensitive input device and the processor 240 interacts with the touch-sensitive overlay 206 via the electronic controller 208.

The processor 240 interacts with additional device subsystems including flash memory 244, random access memory (RAM) 246, read only memory (ROM) 248, auxiliary input/output (I/O) subsystems 250, data port 252 such as serial data port, such as a Universal Serial Bus (USB) data port, speaker 256, microphone 258, control keys 260, switch 261, short-range communication subsystem 272, and other device subsystems generally designated as 274. Some of the subsystems shown in FIG. 2 perform communication-related functions, whereas other subsystems may provide “resident” or on-device functions.

The communication subsystem 211 includes a receiver 214, a transmitter 216, and associated components, such as one or more antenna elements 218 and 222, local oscillators (LOs) 222, and a processing module such as a digital signal processor (DSP) 224. The antenna elements 218 and 222 may be embedded or internal to the mobile communication device 201 and a single antenna may be shared by both receiver and transmitter, as is known in the art. As will be apparent to those skilled in the field of communication, the particular design of the wireless communication subsystem 211 depends on the wireless network 101 in which mobile communication device 201 is intended to operate.

The mobile communication device 201 may communicate with any one of a plurality of fixed transceiver base stations 108 of the wireless network 101 within its geographic coverage area. The mobile communication device 201 may send and receive communication signals over the wireless network 101 after the required network registration or activation procedures have been completed. Signals received by the antenna 218 through the wireless network 101 are input to the receiver 214, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 224. In a similar manner, signals to be transmitted are processed, including modulation and encoding, for example, by the DSP 224. These DSP-processed signals are input to the transmitter 216 for digital-to-analog (D/A) conversion, frequency up conversion, filtering, amplification, and transmission to the wireless network 101 via the antenna 211. The DSP 224 not only processes communication signals, but may also provide for receiver and transmitter control. For example, the gains applied to communication signals in the receiver 214 and the transmitter 216 may be adaptively controlled through automatic gain control algorithms implemented in the DSP 224.

The processor 240 operates under stored program control and executes software modules 221 stored in memory such as persistent memory, for example, in the flash memory 244. The software modules 221 comprise operating system software 223, software applications 225 comprising a user interface (UI) module 282, Web browser module 284, a cursor navigation module 286, and a pan navigation module 288.

The UI module 282 renders and displays a graphical user interface (GUI) on a display 204 of the device 201 in accordance with instructions of the operating system 223 and applications 225 (as applicable). The GUI allows interaction with and control over the process of the device 201. The GUI is rendered prior to display by the operating system 223 or an application 225 which causes the processor 240 to display content on the touchscreen display 210. The Web browser module 284 provides a Web browser application on the device 201. The cursor navigation module 286 is a device application or application component which provides a cursor (navigation) mode for navigating user interface screens displayed on the touchscreen display 210. The pan navigation module 288 is a device application or application component which provides a pan (navigation) mode for navigating user interface screens displayed on the touchscreen display 210.

The cursor navigation module 286 and pan navigation module 288 may, among other things, each be implemented through standalone software applications, or combined together in a common application, the operating system 223 or software application 225 such as the Web browser application. The functions performed by each of the modules 286 and 288 may be realized as a plurality of independent elements, rather than single integrated elements, and any one or more of these elements may be implemented as parts of the operating system 223 or software application 225 such as the Web browser application.

Those skilled in the art will appreciate that the software modules 221 or parts thereof may be temporarily loaded into volatile memory such as the RAM 246. The RAM 246 is used for storing runtime data variables and other types of data or information, as will be apparent to those skilled in the art. Although specific functions are described for various types of memory, this is merely an example, and those skilled in the art will appreciate that a different assignment of functions to types of memory could also be used.

The software applications 225 may include a range of applications, including, for example, an address book application, a messaging application, a calendar application, and/or a notepad application. In some embodiments, the software applications 225 include an email message application, a push content viewing application, a voice communication (i.e. telephony) application, a map application, and a media player application. Each of the software applications 225 may include layout information defining the placement of particular fields and graphic elements (e.g. text fields, input fields, icons, etc.) in the user interface (i.e. the display device 204) according to the application.

In some embodiments, the auxiliary I/O subsystems 250 may comprise an external communication link or interface, for example, an Ethernet connection. The mobile communication device 201 may comprise other wireless communication interfaces for communicating with other types of wireless networks, for example, a wireless network such as an orthogonal frequency division multiplexed (OFDM) network or a GPS transceiver for communicating with a GPS satellite network (not shown). The auxiliary I/O subsystems 250 may comprise a vibrator for providing vibratory notifications in response to various events on the mobile communication device 201 such as receipt of an electronic communication or incoming phone call, or for other purposes such as haptic feedback (touch feedback).

In some embodiments, the mobile communication device 201 also includes a removable memory card 230 (typically comprising flash memory) and a memory card interface 232. Network access typically associated with a subscriber or user of the mobile communication device 201 via the memory card 230, which may be a Subscriber Identity Module (SIM) card for use in a GSM network or other type of memory card for use in the relevant wireless network type. The memory card 230 is inserted in or connected to the memory card interface 232 of the mobile communication device 201 in order to operate in conjunction with the wireless network 101.

The mobile communication device 201 stores data 227 in an erasable persistent memory, which in one example embodiment is the flash memory 244. In various embodiments, the data 227 includes service data comprising information required by the mobile communication device 201 to establish and maintain communication with the wireless network 101. The data 227 may also include user application data such as email messages, address book and contact information, calendar and schedule information, notepad documents, image files, and other commonly stored user information stored on the mobile communication device 201 by its user, and other data. The data 227 stored in the persistent memory (e.g. flash memory 244) of the mobile communication device 201 may be organized, at least partially, into a number of databases each containing data items of the same data type or associated with the same application. For example, email messages, contact records, and task items may be stored in individual databases within the device memory.

The serial data port 252 may be used for synchronization with a user's host computer system (not shown). The serial data port 252 enables a user to set preferences through an external device or software application and extends the capabilities of the mobile communication device 201 by providing for information or software downloads to the mobile communication device 201 other than through the wireless network 101. The alternate download path may, for example, be used to load an encryption key onto the mobile communication device 201 through a direct, reliable and trusted connection to thereby provide secure device communication.

In some embodiments, the mobile communication device 201 is provided with a service routing application programming interface (API) which provides an application with the ability to route traffic through a serial data (i.e., USB) or Bluetooth® connection to the host computer system using standard connectivity protocols. When a user connects their mobile communication device 201 to the host computer system via a USB cable or Bluetooth® connection, traffic that was destined for the wireless network 101 is automatically routed to the mobile communication device 201 using the USB cable or Bluetooth® connection. Similarly, any traffic destined for the wireless network 101 is automatically sent over the USB cable Bluetooth® connection to the host computer system for processing.

The mobile communication device 201 also includes a battery 238 as a power source, which is typically one or more rechargeable batteries that may be charged, for example, through charging circuitry coupled to a battery interface such as the serial data port 252. The battery 238 provides electrical power to at least some of the electrical circuitry in the mobile communication device 201, and the battery interface 236 provides a mechanical and electrical connection for the battery 238. The battery interface 236 is coupled to a regulator (not shown) which provides power V+ to the circuitry of the mobile communication device 201.

The short-range communication subsystem 272 is an additional optional component which provides for communication between the mobile communication device 201 and different systems or devices, which need not necessarily be similar devices. For example, the subsystem 272 may include an infrared device and associated circuits and components, or a wireless bus protocol compliant communication mechanism such as a Bluetooth® communication module to provide for communication with similarly-enabled systems and devices (Bluetooth® is a registered trademark of Bluetooth SIG, Inc.).

A predetermined set of applications that control basic device operations, including data and possibly voice communication applications will normally be installed on the mobile communication device 201 during or after manufacture. Additional applications and/or upgrades to the operating system 223 or software applications 225 may also be loaded onto the mobile communication device 201 through the wireless network 101, the auxiliary I/O subsystem 250, the serial port 252, the short-range communication subsystem 272, or other suitable subsystem 274 other wireless communication interfaces. The downloaded programs or code modules may be permanently installed, for example, written into the program memory (i.e. the flash memory 244), or written into and executed from the RAM 246 for execution by the processor 240 at runtime. Such flexibility in application installation increases the functionality of the mobile communication device 201 and may provide enhanced on-device functions, communication-related functions, or both. For example, secure communication applications may enable electronic commerce functions and other such financial transactions to be performed using the mobile communication device 201.

The mobile communication device 201 may include a personal information manager (PIM) application having the ability to organize and manage data items relating to a user such as, but not limited to, instant messaging, email, calendar events, voice mails, appointments, and task items. The PIM application has the ability to send and receive data items via the wireless network 101. In some example embodiments, PIM data items are seamlessly combined, synchronized, and updated via the wireless network 101, with the user's corresponding data items stored and/or associated with the user's host computer system, thereby creating a mirrored host computer with respect to these data items.

The mobile communication device 201 may provide two principal modes of communication: a data communication mode and an optional voice communication mode. In the data communication mode, a received data signal such as a text message, an email message, or Web page download will be processed by the communication subsystem 211 and input to the processor 240 for further processing. For example, a downloaded Web page may be further processed by a browser application or an email message may be processed by an email message application and output to the display 204. A user of the mobile communication device 201 may also compose data items, such as email messages, for example, using the touch-sensitive overlay 206 in conjunction with the display device 204 and possibly the control buttons 260 and/or the auxiliary I/O subsystems 250. These composed items may be transmitted through the communication subsystem 211 over the wireless network 101.

In the voice communication mode, the mobile communication device 201 provides telephony functions and operates as a typical cellular phone. The overall process is similar, except that the received signals would be output to the speaker 256 and signals for transmission would be generated by a transducer such as the microphone 258. The telephony functions are provided by a combination of software/firmware (i.e., the voice communication module) and hardware (i.e., the microphone 258, the speaker 256 and input devices). Alternative voice or audio I/O subsystems, such as a voice message recording subsystem, may also be implemented on the mobile communication device 201. Although voice or audio signal output is typically accomplished primarily through the speaker 256, the display device 204 may also be used to provide an indication of the identity of a calling party, duration of a voice call, or other voice call related information.

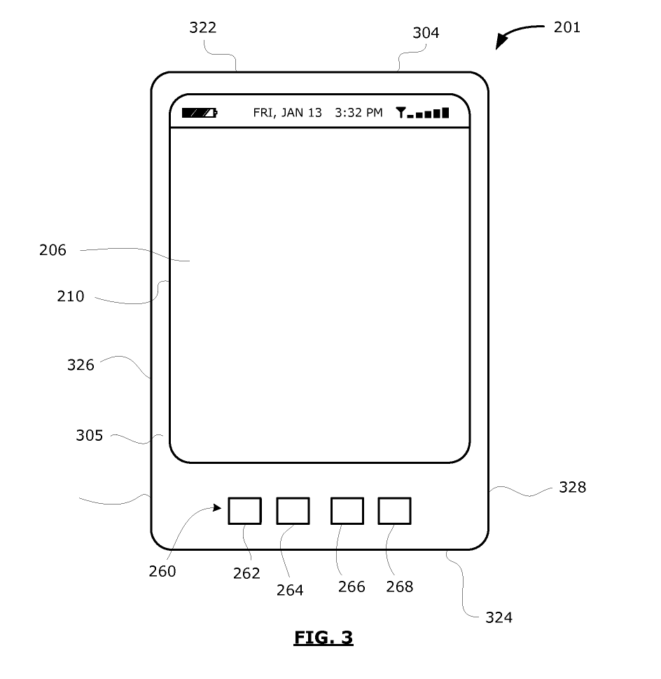

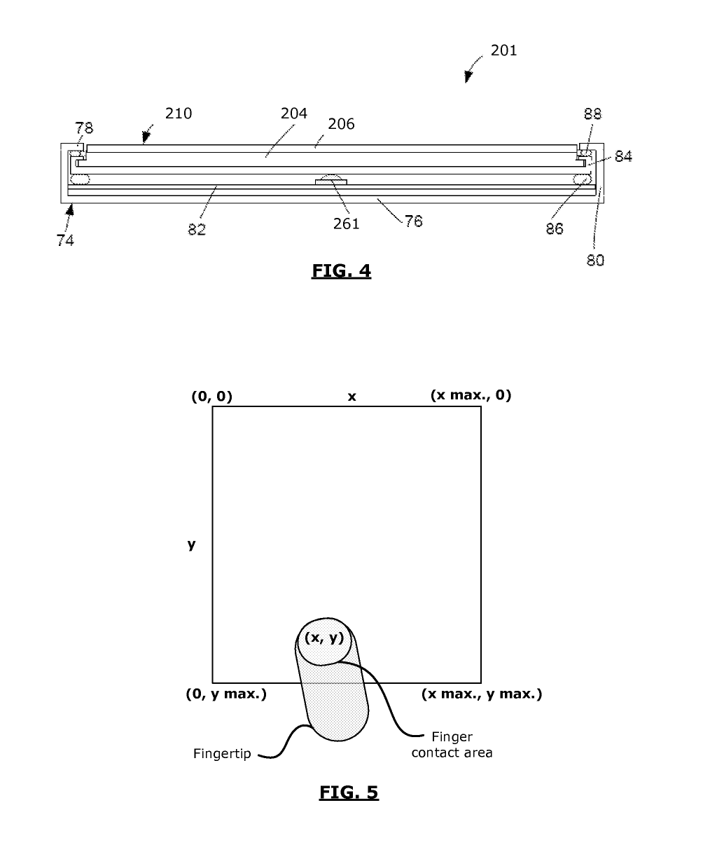

Referring now to FIGS. 3A, 3B and 4, the construction of the device 201 will be described in more detail. The device 201 includes a rigid case 304 for housing the components of the device 201 that is configured to be held in a user's hand while the device 201 is in use. The touchscreen display 210 is mounted within a front face 305 of the case 304 so that the case 304 frames the touchscreen display 210 and exposes it for user-interaction therewith. The case 304 has opposed top and bottom ends designated by references 322, 324 respectively, and left and right sides designated by references 326, 328 respectively which extend transverse to the top and bottom ends 322, 324. In the shown embodiments of FIGS. 3A and 3B, the case 304 (and device 201) is elongate having a length defined between the top and bottom ends 322, 324 longer than a width defined between the left and right sides 326, 328. Other device dimensions are also possible.

The case 304 includes a back 76, a frame 78 which frames the touch-sensitive display 210, sidewalls 80 that extend between and generally perpendicular to the back 76 and the frame 78, and a base 82 that is spaced from and generally parallel to the back 76. The base 82 can be any suitable base and can include, for example, a printed circuit board or flex circuit board (not shown). The back 76 includes a plate (not shown) that is releasably attached for insertion and removal of, for example, the battery 238 and the memory module 288 described above. It will be appreciated that the back 76, the sidewalls 80 and the frame 78 can be injection molded, for example.

The display device 204 and the overlay 206 can be supported on a support tray 84 of suitable material such as magnesium for providing mechanical support to the display device 204 and overlay 206. The display device 204 and overlay 206 are biased away from the base 82, toward the frame 78 by biasing elements 86 such as gel pads between the support tray 84 and the base 82. Compliant spacers 88 which, for example, can also be in the form of gel pads are located between an upper portion of the support tray 84 and the frame 78. The touchscreen display 210 is moveable within the case 304 as the touchscreen display 210 can be moved toward the base 82, thereby compressing the biasing elements 86. The touchscreen display 210 can also be pivoted within the case 304 with one side of the touchscreen display 210 moving toward the base 82, thereby compressing the biasing elements 86 on the same side of the touchscreen display 210 that moves toward the base 82.

In the example embodiment, the switch 261 is supported on one side of the base 82 which can be a printed circuit board while the opposing side provides mechanical support and electrical connection for other components (not shown) of the device 201. The switch 261 can be located between the base 82 and the support tray 84. The switch 261, which can be a mechanical dome-type switch, for example, can be located in any suitable position such that displacement of the touchscreen display 210 resulting from a user pressing the touchscreen display 210 with sufficient force to overcome the bias and to overcome the actuation force for the switch 261, depresses and actuates the switch 261. In the present embodiment the switch 261 is in contact with the support tray 84. Thus, depression of the touchscreen display 210 by application of a force thereto, causes actuation of the switch 261, thereby providing the user with a positive tactile quality during user interaction with the user interface of the 201. The switch 261 is not actuated in the rest position shown in FIG. 4, absent applied force by the user. It will be appreciated that the switch 261 can be actuated by pressing anywhere on the touchscreen display 210 to cause movement of the touchscreen display 210 in the form of movement parallel with the base 82 or pivoting of one side of the touchscreen display 210 toward the base 82. The switch 261 is connected to the processor 240 and can be used for further input to the processor when actuated. Although a single switch is shown any suitable number of switches can be used.

The touchscreen display 210 can be any suitable touchscreen display such as a capacitive touchscreen display. A capacitive touchscreen display 210 includes the display device 204 and the touch-sensitive overlay 206, in the form of a capacitive touch-sensitive overlay 206. It will be appreciated that the capacitive touch-sensitive overlay 206 includes a number of layers in a stack and is fixed to the display device 204 via a suitable optically clear adhesive. The layers can include, for example a substrate fixed to the display device 204 (e.g. LCD display) by a suitable adhesive, a ground shield layer, a barrier layer, a pair of capacitive touch sensor layers separated by a substrate or other barrier layer, and a cover layer fixed to the second capacitive touch sensor layer by a suitable adhesive. The capacitive touch sensor layers can be any suitable material such as patterned indium tin oxide (ITO).

Each of the touch sensor layers comprises an electrode layer each having a number of spaced apart transparent electrodes. The electrodes may be a patterned vapour-deposited ITO layer or ITO elements. The electrodes may be, for example, arranged in an array of spaced apart rows and columns. The touch sensor layers/electrode layers are each associated with a coordinate (e.g., x or y) in a coordinate system used to map locations on the touchscreen display 210, for example, in Cartesian coordinates (e.g., x and y-axis coordinates). The intersection of the rows and columns of the electrodes may represent pixel elements defined in terms of an (x, y) location value which can form the basis for the coordinate system. Each of the touch sensor layers provide a signal to the controller 208 which represent the respective x and y coordinates of the touchscreen display 210. That is, x locations are provided by a signal generated by one of the touch sensor layers and y locations are provided by a signal generated by the other of the touch sensor layers.

The electrodes in the touch sensor layers/electrode layers respond to changes in the electric field caused by conductive objects in the proximity of the electrodes. When a conductive object is near or contacts the touch-sensitive overlay 206, the object draws away some of the charge of the electrodes and reduces its capacitance. The controller 208 receives signals from the touch sensor layers of the touch-sensitive overlay 206, detects touch events by determining changes in capacitance which exceed a predetermined threshold, and determines the centroid of a contact area defined by electrodes having a change in capacitance which exceeds the predetermined threshold, typically in x, y (Cartesian) coordinates.

The controller 208 sends the centroid of the contact area to the processor 240 of the device 201 as the location of the touch event detected by the touchscreen display 210. Depending on the touch-sensitive overlay 206 and/or configuration of the touchscreen display 210, the change in capacitance which results from the presence of a conductive object near the touch-sensitive overlay 206 but not contact the touch-sensitive overlay 206, may exceed the predetermined threshold in which case the corresponding electrode would be included in the contact area. The detection of the presence of a conductive object such as a user's finger or a conductive stylus is sometimes referred to as finger presence/stylus presence.

It will be appreciated that other attributes of a touch event on the touchscreen display 210 can be determined. For example, the size and the shape (or profile) of the touch event on the touchscreen display 210 can be determined in addition to the location based on the signals received at the controller 208 from the touch sensor layers. For example, the touchscreen display 210 may be used to create a pixel image of the contact area created by a touch event. The pixel image is defined by the pixel elements represented by the intersection of electrodes in the touch sensor layers/electrode layers. The pixel image may be used, for example, to determine a shape or profile of the contact area.

The centroid of the contact area is calculated by the controller 208 based on raw location and magnitude (e.g., capacitance) data obtained from the contact area. The centroid is defined in Cartesian coordinates by the value (X_{c}, Y_{c}). The centroid of the contact area is the weighted averaged of the pixels in the contact area and represents the central coordinate of the contact area. By way of example, the centroid may be found using the following equations:

$$\begin{matrix}{X}_{c} = \frac{{\sum }_{i = 1}^{n} {Z}_{i} * {x}_{i}}{{{\sum }_{i = 1}}^{n} {Z}_{i}} & ( 1 ) \\ {Y}_{c} = \frac{{\sum }_{i = 1}^{n} {Z}_{i} * {y}_{i}}{{{\sum }_{i = 1}}^{n} {Z}_{i}} & ( 2 )\end{matrix}$$

where X_{c} represents the x-coordinate of the centroid of the contact area, Y_{c} represents the y-coordinate of the centroid of the contact area, x represents the x-coordinate of each pixel in the contact area, y represents the y-coordinate of each pixel in the contact area, Z represents the magnitude (capacitance value or resistance) at each pixel in the contact area, the index i represents the electrodes in the contact area and n represents the number of electrodes in the contact area. Other methods of calculating the centroid will be understood to persons skilled in the art.

The controller 208 of the touchscreen display 210 is typically connected using both interpret and serial interface ports to the processor 240. In this way, an interrupt signal which indicates a touch event has been detected, the centroid of the contact area, as well as raw data regarding the location and magnitude of the activated electrodes in the contact area are passed to the processor 240. However, in other embodiments only an interrupt signal which indicates a touch event has been detected and the centroid of the contact area are passed to the processor 240. In embodiments where the raw data is passed to the processor 240, the detection of a touch event (i.e., the application of an external force to the touch-sensitive overlay 206) and/or the determination of the centroid of the contact area may be performed by the processor 240 of the device 201 rather than the controller 208 of the touchscreen display 210.

Referring now to FIG. 5, a Cartesian (two-dimensional) coordinate system used to map locations of the touchscreen display 210 in accordance with one embodiment of the present disclosure will be described. The touchscreen display 210 defines a Cartesian coordinate system defined by x and y-axes in the input plane of the touchscreen display 210. Each touch event on the touchscreen display 210 returns a touchpoint (also referred tows the touch location or hotspot) defined in terms of an (x, y) value. The returned touchpoint is the centroid of the contact area in the described embodiments.

In the shown embodiment, the touchscreen display 210 has a rectangular touch-sensitive overlay 206; however, in other embodiments, the touch-sensitive overlay 206 could have a different shape such as a square shape. The rectangular touch-sensitive overlay 206 results in a screen which is divided into a rectangle of pixels with positional values ranging from 0 to the maximum in each of the x and y-axes (x max. and y max. respectively). The x-axis extends in the same direction as the width of the device 201 and the touch-sensitive overlay 206. The y-axis extends in the same direction as the length of the device 201 and the touch-sensitive overlay 206.

The coordinate system has an origin (0, 0) which is located at the top left-hand side of the touchscreen display 210. For purposes of convenience, the origin (0, 0) of the Cartesian coordinate system is located at this position in all of the embodiments described in the present disclosure. However, it will be appreciated that in other embodiments the origin (0, 0) could be located elsewhere such as at the bottom left-hand side of the touchscreen display 210, the top right-hand side of the touchscreen display 210, or the bottom right-hand side of the touchscreen display 210. The location of the origin, (0, 0) could be configurable in other embodiments.

A GUI for controlling the process of the device is displaying on the touchscreen display 210 during process. The GUI is rendered prior to display by the operating system 223 or an application 225 which causes the processor 240 to display content on the touchscreen display 210. The GUI of the device 201 has a screen orientation in which the text and user interface elements of the GUI are oriented for normal viewing. It will be appreciated that the screen orientation for normal viewing independent of the language supported, that is the screen orientation for normal viewing is the same regardless of whether a row-oriented language or column-oriented language (such as Asian languages) is displayed within the GUI. Direction references in relation to the GUI, such as top, bottom, left, and right, are relative to the current screen orientation of the GUI rather than the device 201 or its case 304.

In embodiments such as that shown in FIG. 5 in which the display screen is rectangular in shape, the screen orientation is either portrait (vertical) or landscape (horizontal). A portrait screen orientation is a screen orientation in which the text and other user interface elements extend in a direction transverse (typically perpendicular) to the length (y-axis) of the display screen. A landscape screen orientation is a screen orientation in which the text and other user interface elements extend in a direction transverse (typically perpendicular) to the width (x-axis) of the display screen. In some embodiments, the GUI of the device 201 changes its screen orientation between a portrait screen orientation and landscape screen orientation in accordance with changes in device orientation. In other embodiments, the GUI of the device 201 does not change its screen orientation based on changes in device orientation.

In other embodiments, the touchscreen display 210 may be a display device, such as an LCD screen, having the touch-sensitive input surface (overlay) 206 integrated therein. An example of such a touchscreen is described in commonly owned U.S. patent publication no. 2004/0155991, published Aug. 12, 2004 (also identified as U.S. patent application Ser. No. 10/717,877, filed Nov. 20, 2003) which is incorporated herein by reference.

While specific embodiments of the touchscreen display 210 have been described, any suitable type of touchscreen in the handheld electronic device of the present disclosure including, but not limited to, a capacitive touchscreen, a resistive touchscreen, a surface acoustic wave (SAW) touchscreen, an embedded photo cell touchscreen, an infrared (IR) touchscreen, a strain gauge-based touchscreen, an optical imaging touchscreen, a dispersive signal technology touchscreen, an acoustic pulse recognition touchscreen or a frustrated total internal reflection touchscreen. The type of touchscreen technology used in any given embodiment will depend on the handheld electronic device and its particular application and demands.

Referring again to FIG. 3, the control buttons or keys 260, represented individually by references 262, 264, 266, 268, which are located below the touchscreen display 210 on the front face 305 of the device 201 which generate corresponding input signals when activated. The control keys 260 may be construction using any suitable key construction, for example, the controls keys 260 may each comprise a dome-switch. In other embodiments, the control keys 260 may be located elsewhere such as on a side of the device 201. If no control keys are provided, the function of the control keys 262-268 described below may be provided by one or more virtual keys (not shown), which may be part of a virtual toolbar or virtual keyboard.

In some embodiments, the input signals generated by activating (e.g. depressing) the control keys 262 are context-sensitive depending on the current/active operational mode of the device 201 or current/active application 225. The key 262 may be a send/answer key which can be used to answer an incoming voice call, bring up a phone application when there is no incoming voice call, and start a phone call from the phone application when a phone number is selected within that application. The key 264 may be a menu key which invokes context-sensitive menus comprising a list of context-sensitive options. The key 266 may be an escape/back key which cancels the current action, reverses (e.g., “back up” or “go back”) through previous user interface screens or menus displayed on the touchscreen display 210, or exits the current application 225. The key 268 may be an end/hang up key which ends the current voice call or hides the current application 225.

### Pan Navigation Mode

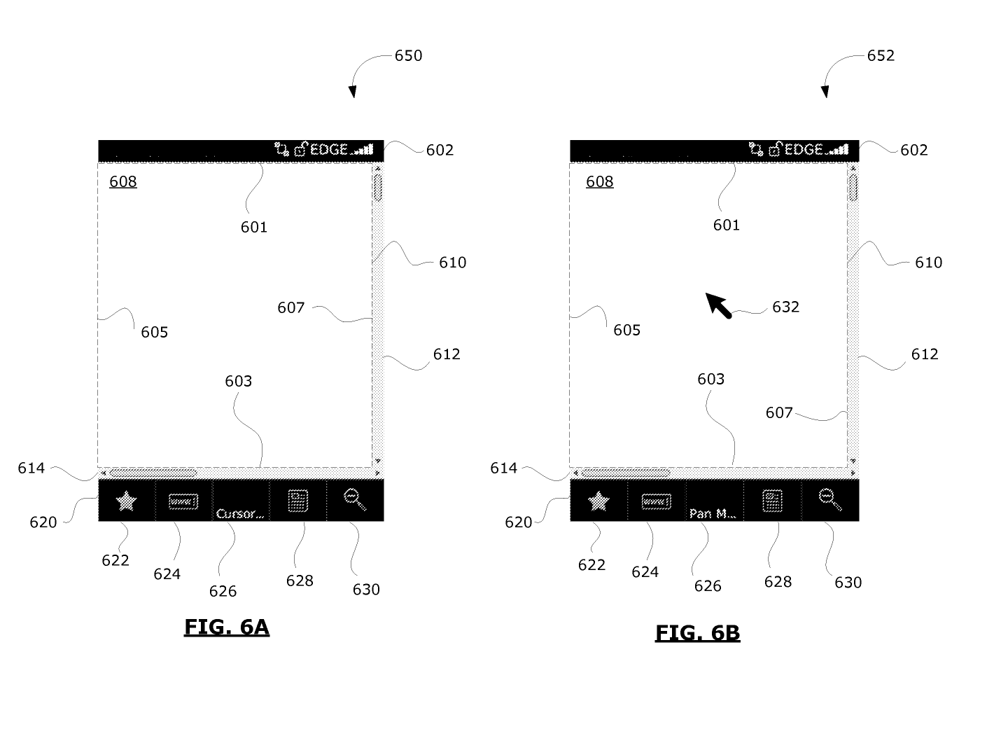

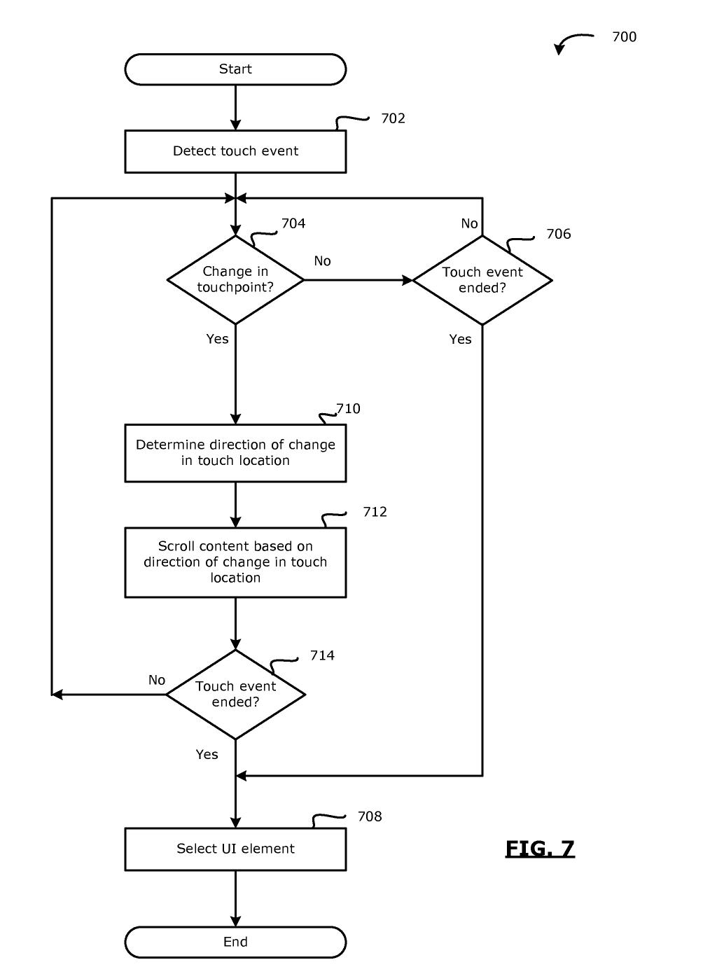

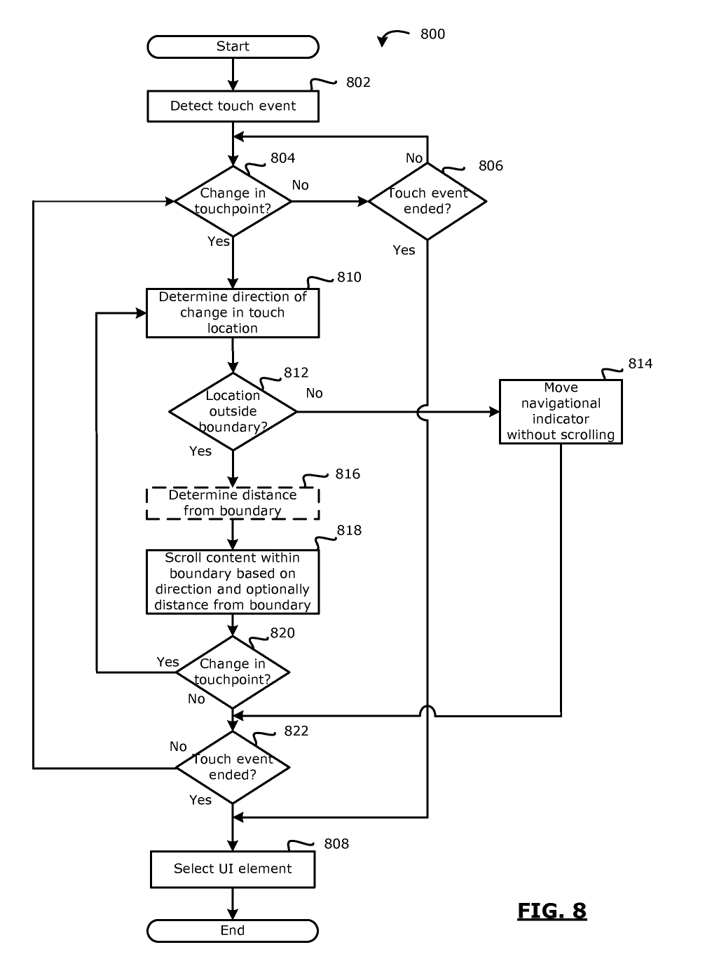

Referring now to FIGS. 6A and 7, a pan navigation mode of the graphical user interface (GUI) of the device 201 in accordance with one example embodiment of the present disclosure will now be described. As described below, the pan navigation mode allows navigation within the GUI in a manner which tracks the movement of the device user's finger during contact with the touchscreen display 201. That is, the user interface at the touchpoint moves with the user's finger until it is removed. Examples of such navigational movements are touch-and-drag and swipe events which are described more fully below. For the purpose of convenience, interaction with the touchscreen display 210 will be described in the context of a finger of the device user. However, it will be appreciated that a conductive stylus or other object could be used for interacting with the touchscreen display 210 depending on the type of touchscreen display 210.

FIG. 6A illustrates a screen shot of a user interface screen 650 of a pan navigation mode of the Web browser application in a portrait screen orientation. The GUI includes a display area 608 defined by a “virtual” boundary 610. The boundary 610 is defined by a top border 601, a bottom border 604, a left border 605 and a right border 607. The boundary 610 may constrain content displayed in the display area 608. The content displayed in the area 608 may be scrollable in the horizontal direction (e.g., left/right direction of the GUI), the vertical direction (e.g., up/down direction of the GUI,) or both depending on its format, length and/or size.

In the shown embodiment, the boundary 610 is defined by a window or frame of the Web browser application in which a web page is displayed. However, the boundary 610 could be defined by the entire displayable area of the touchscreen display 210, or other user interface elements of the GUI within the displayable area of the touchscreen display 210. In shown embodiment, the top of the display area 608 is bounded by a status bar 602 which displays information such as the current date and time, icon-based notifications, device status and/or device state. The left side of the display area 608 is bounded by a virtual border representing the left-hand side of the displayable area of the GUI in display area 608. The right side of the display area 608 is bounded by a vertical scrollbar 612. The bottom of the display area 608 is bounded by a horizontal scrollbar 614. Depending on the format and amount of content to be displayed in the display area 608, the pan navigation mode may have a vertical scrollbar 612 for vertically scrolling (e.g. page up/page down), a horizontal scrollbar 614 for horizontal scrolling (e.g. page left/page right), both a vertical scrollbar 612 and horizontal scrollbar 614, or no scrollbars. Scrolling via either the pan navigation mode or cursor navigation mode described herein will cause corresponding changes to the vertical scrollbar 612 and/or horizontal scrollbar 614, if any. In some embodiments, vertical scrollbar 612 and/or horizontal scrollbar 614 (if any) could be used for scrolling in addition to the pan navigation mode and/or cursor navigation modes.

The user interface screen 650 also includes a toolbar 620 having a plurality of selectable virtual buttons. The toolbar 620 may be displayed (shown) or hidden in response to respective input from the touchscreen overlay 206. In some inputs, the input to show or hide the toolbar 620 is a single-tap on the touchscreen display 210. In some embodiments, the toolbar 620 is automatically displayed when entering the pan navigation mode but can be hidden. Whether the toolbar 620 is shown or hidden upon entering the pan navigation mode may be a configurable setting.

In the shown embodiment, the toolbar 620 is displayed at the bottom of the user interface screen 650 and below the horizontal scrollbar 614. In other embodiments, the toolbar 620 may be located at the top of the content display area 608, possibly below the status bar 602. In yet other embodiments, there may no horizontal scrollbar 614 or no status bar 602. In yet other embodiments, the toolbar 620 may extend vertically on either the left or right side of the GUI.

In the shown embodiment, the toolbar 620 extends horizontally across the GUI and includes five buttons represented individually by references 622, 624, 626, 628 and 630 which are of equal size. In other embodiments, a different number of buttons may be provided by the toolbar 620 and the buttons which are provided may be different sizes and/or spaced part. In the shown embodiment, the button 622 is a “Favourites” button for invoking a favourites user interface screen to request or add favourite links, the button 624 is a “Go to” button for invoking a user interface screen for inputting a link or URL to access using the Web browser application, the button 628 is a context-sensitive button for changing the page resolution/size. The function and appearance of the button 628 varies depending on the current page resolution/size. In the shown user interface screen 650, the button 628 is a “reset” or “normal view” button for returning the page resolution/size to a “normal” resolution/size, but could be a “zoom in” button when the current page resolution/size is “normal”.

One of the virtual buttons in the toolbar 620 is a navigation “switch mode” button 626 for switching between the pan navigation mode and cursor navigation mode, and vice versa. In the shown embodiment, the switch mode button 626 is the centre button in the toolbar 620; however, it could be located elsewhere in the toolbar 620 in other embodiments. The centre location in the toolbar 620 may be advantageous for convenient switching between navigation modes as it is easily accessible by the thumb or finger of a device user during left-handed, right-handed, or two-handed use.

It will be appreciated that the switch mode button 626 is context-sensitive. That is, selection of the switch mode button 626 in the pan navigation mode changes the navigation mode to the cursor navigation mode. As shown in FIG. 6A, in some embodiments of GUI of the pan navigation mode, visual indicia is displayed within the switch mode button 626 to provide a visual representation that the function of the button is to change the navigation mode to the cursor navigation mode. This allows the device user to more easily identify the function associated with the virtual button and more quickly select the switch mode button 626 to switch between navigation modes. The visual indicia for the switch mode button 626 may be text such as “Cursor Mode”, “Cursor Navigation Mode” or “Cursor . . . ”, or an icon or other pictorial representation which is identifiable by the device user.

Different types of touch events which are recognized by the example embodiment of the GUI will now be described. The different types of touch events on the touchscreen display 210 which are recognized are a single-tap, double-tap, touch, touch-and-drag and swipe.

As a preliminary matter, the terms “tap” and “touch” will be explained. A tap and touch are differentiated by the duration of substantiated or continuous contact with the touchscreen display 210. This is performed by the controller 208 of the touchscreen display 210 or the processor 240, depending on the embodiment. When a touch event is less than a predetermined duration, it is considered a tap. The predetermined duration could be, in some embodiments, 200 to 300 milliseconds. The predetermined duration could be configurable. In order words, a tap is performing by quickly striking the touchscreen display 210 with the user's finger. A double-tap is the occurrence of two discrete taps within a predetermined duration which may be configurable. When the touch event is greater than or equal to the predetermined duration, it is considered a touch.

In the pan navigation mode, in at least some embodiments, a single-tap on the touchscreen display 210 causes the toolbar 620 to be shown when it is not currently displayed and hidden when it is displayed. In other embodiments, the toolbar 620 could always be shown. In at least some embodiments, a double-tap causes the content at the touchpoint to be magnified (e.g., causes displayed text to be enlarged or causes a “zoom in” on an image). If the content at the touchpoint is a link to a pop-up user interface screen or window, the double-tap expands the pop-up user interface screen associated with the link.

In contrast to a tap, a touch causes a user interface element such as a button, icon, text or link associated with the respective location on the touchscreen display 210 to be selected. Selection causes the user interface element to be highlighted or focused using an onscreen visual indicator (not shown). In some embodiments, the highlighting a link comprises changing the background colour of the link, changing the text colour of the link, or both. The highlighting of a button or icon involves changing the background colour of the button or icon. In some embodiments, highlighting causes the appearance of the selected button or icon to be changed from a first version (e.g., idle/unselected) to a second version (e.g., active/selected). For example, touching a button in the virtual toolbar 620 such as the switch mode button 626 causes the background colour to be changed from black (unselected) to blue (selected). The button is highlighted in blue to provide the user with a visual indication that the button has been selected. In other embodiments, the selected user interface element could be changed in appearance in other ways to provide the user with a visual indication of the user interface element which is currently selected rather than highlighting it.

In the pan navigation mode, the selection of a user interface element does not activate the associated command, function or application 225. Activation of a user interface element in the pan navigation mode requires a separate “click” action at the respective location on the touchscreen display 210. “Clicking” is performed by depressing the touchscreen display 210 so as to cause depression of the switch 261. A click event generates an interrupt signal from the switch 261, an interrupt signal from the touchscreen display 210 and possibly a serial data signal from the touchscreen display 210. When a user interface element of the GUI is selected (e.g., highlighted or focussed by the onscreen visual indicator), clicking the touchscreen display 210 causes the activation of the selected user interface element. If the user interface element represents a function, command or application 225, activation of the selected user interface element causes the processor 240 to execute the function, command or application 225 logically associated with the user interface element.

Thus, in the pan navigation mode, selecting and clicking an interactive user interface element (e.g. virtual button, icon or link) causes it to be activated, causing the function, command or application 225 associated with it to be executed by the processor 240. However, selecting and clicking the touchscreen display 210 at the location of an input field causes a navigational indicator (not shown) such as a caret or cursor to be moved to that input field and to pop-up a virtual keyboard (not shown).

Although in the above described embodiment an interactive user interface element is typically available for activation (e.g., to be clicked) only after having been first selected by touching it, in other embodiments, interactive user interface elements could be activated (e.g., clicked) without having been previously selected.

A touch may have a directional component resulting from movements in the touchpoint during the substantiated or continuous contact with the touchscreen display 210. The direction of a touch is described by location information in the form of two-dimensional coordinate (e.g., x, y) values returned from the touchscreen display 210. The two-dimensional coordinate values can be transformed into one or more directions of movement by the controller 208 of the touchscreen display 210 or the processor 240, depending on the embodiment. There are two types of directional touch events: a touch-and-drag (or touch-and-grab) and a swipe.

A touch-and-drag can have one or more directions and is performed by moving the finger contacting the touchscreen display 210, stopping it, and then removing the finger from the touchscreen display 210. During a touch-and-drag, the GUI scrolls the page in a manner which tracks the movement of the user's finger. That is, the user interface element at the touchpoint moves with the user's finger until it is removed. In accordance with some embodiments, when the movement of the touchpoint is within a predetermined threshold of a vertical or horizontal axis of the GUI, the direction of scrolling is locked to the vertical or horizontal axis in dependence on which axis the direction of touchpoint movement is closest to. The predetermined threshold is typically only a few degrees from the vertical or horizontal axis of the GUI. It is understood that touchpoint movements which are primarily up or down relative to the screen orientation of the GUI are closest to its vertical axis, whereas touchpoint movements which are primarily left or right relative to the screen orientation of the GUI are closest to its horizontal axis.

The page displayed in the display area 608 is then scrolled up in response to down movement, down in response to up movement, left in response to right movement, and right in response to left movement. Displayed content in within the boundary 610 moves (or tracks) with the finger movement and movement of the touchpoint. The pan navigation mode is sometimes referred to as the “paper metaphor navigation mode” or “finger-on-paper metaphor navigation mode” with the display area 608 being analogous to a sheet of paper. The scrolling of the displayed content in the pan navigation mode can be equated to moving a sheet of paper using the user's fingertip. The underlying content at the original touchpoint moves with user's finger or other pointing device during the touch event. That is, the underlying content moves with the user's fingertip or other pointing device as the user moves the touchpoint around the touchscreen display 210.

When the touchpoint movement is not within the predetermined threshold (i.e., more than a few degrees from the vertical or horizontal axis; the touchpoint movement being more diagonal), free scrolling of the page or other content displayed in the display area 608 occurs in two-dimensions. This is sometimes referred to as “free movement” mode. In such cases, the scrolling movement of the content within the display area 608 tracks the movement of the touchpoint in whatever two dimensional direction the touchpoint moves.

In accordance with other embodiments, the direction closest to the touchpoint movement is determined, the direction being selected from an up, down, left or right direction relative to the screen orientation of the GUI. The page displayed in the display area 608 is then scrolled up in response to down, movement, down in response to up movement, left in response to right movement, and right in response to left movement. No thresholds are analyzed and no “free movement” is provided. Such embodiments effectively provide the same locked movement described above but no “free movement”.

The page is scrolled in an amount proportional to the movement and occurs in real-time rather than after movement stops. In some embodiments, the amount by which the page is scrolled is proportional to the detected movement. In some embodiments, the amount by which the page is scrolled relative to the detected movement is 1:1; however, a different ratio could be used in other embodiments, for example, to amplify the effect of finger movement on scrolling action.

A swipe (also referred to as a page up/page down) has one direction and is performed by moving the finger contacting the touchscreen display 210 and removing it while in motion (e.g., without stopping it). A swipe is similar to a touch-and-drag until the finger is removed at speed. A swipe scrolls the page in the display area 608 in the relevant direction by a full page. The page in the is scrolled up or down by an amount equal to the (vertical) height of the boundary 610 in response to respective up or down movement, and the page is scrolled left or right by an amount equal to the (horizontal) width of the boundary 610 in response to respective left or right movement. Thus, a swipe gesture triggers a page up/page down or page left/right command which scrolls the page one “full screen” in the direction of the swipe.

Referring now to FIG. 7, an example process 700 of the pan navigation mode in accordance with one example embodiment of the present disclosure will now be described. As shown in FIG. 6A, the GUI has a boundary 610 which defines an area 608 in which scrollable content such as a menu, Web page or other content page is displayed. In a first step 702, a touch event is detected in response to the user touching the touchscreen display 210. The touchpoint of the touch event is defined in terms of an x and y location or other two-dimensional coordinates returned from the touchscreen display 210. In some embodiments, the x and y location of the touch event may be compared to the coordinates of the boundary 610 to determine whether the x and y location of the touch event are within the area 608 defined by the boundary 610. In such embodiments, the process 700 continues only when the x and y location of the touch event are within the boundary 610.

Next, in step 704 it is determined whether there is a change in the touchpoint of the touch event. The x and y location of touch is determined and compared to the first determined x and y location from step 702, and any change in the x and y location is determined. If there is no change in the x and y location of the touch event, or a change that is below a predetermined threshold, no change in the touchpoint of the touch event is detected. If there is a change in the x and y location of the touch event, or a change that is greater than a predetermined threshold, a change in the touchpoint of the touch event is detected.

If the touchpoint has not changed (step 704), processing proceeds to step 706 where it is determined whether the touch event has ended. The touch event ends when contact with the touchscreen display is broken (e.g., the user lifts their finger or pointing device from the input surface of the touchscreen display 210). In the shown embodiment, the user interface element that corresponds to the x and y location of the touch event prior to the end of the touch event is selected (708). The selection could be the same user interface element, for example, if the touchpoint did not move between the starting and ending of the touch event. Alternatively, in other embodiments the process 700 ends when the touch event has ended.

When the touch event has not ended, the process 700 returns to step 704 where it is again determined if the touchpoint of touch event has changed. The touchpoint is then monitored to determine any changes during the touch event.

Referring again to step 704, when the touchpoint has changed, the direction of the change in the touchpoint relative to the screen orientation of the GUI is then determined based on the x and y location determined at step 702 and the new x and y location of touch event (step 710).

Next, in step 712 the content displayed within the area 608 defined by the boundary 610 is scrolled in accordance with a direction of the change in the location of the touchpoint when additional content is available. It is understood that the additional content must be available in the direction of scrolling, which in the pan navigation mode, is opposite to direction of movement of the touch point.

As will be appreciated by persons skilled in the art, in the pan navigation mode, scrolling of the displayed content requires rendering the respective content and displaying the newly rendered content by the UI module 282 or other module 221, possibly along with the remainder of the user interface screen 750. Scrolling content in the pan navigation mode comprises: scrolling upward on the page in response to a downward change in the touchpoint; scrolling downward on the page in response to a upward change in the touchpoint; scrolling leftward on the page in response to a rightward change in the touchpoint; and scrolling rightward on the page in response to leftward change in the touchpoint. As noted above, the page is scrolled in an amount proportional to the movement.

Next, processing proceeds to step 714 where it is determined whether the touch event has ended. When the touch event has not ended, the process 700 returns to step 704 where it is again determined if the touchpoint of the touch event has changed. The touchpoint is then monitored to determine any changes during the touch event. In the shown embodiment, the user interface element that corresponds to the x and y location of the touch event prior to the end of the touch event is selected (708). The selection could be the same user interface element, for example, if the touchpoint did not move between the starting and ending of the touch event. Alternatively, in other embodiments the process 700 ends when the touch event has ended.

It will be appreciated that the process shown and described with reference to FIG. 7 is simplified for the purpose of the present explanation and other steps and substeps may be included. Alternatively, some of the steps and substeps may be excluded.

### Cursor Navigation Mode

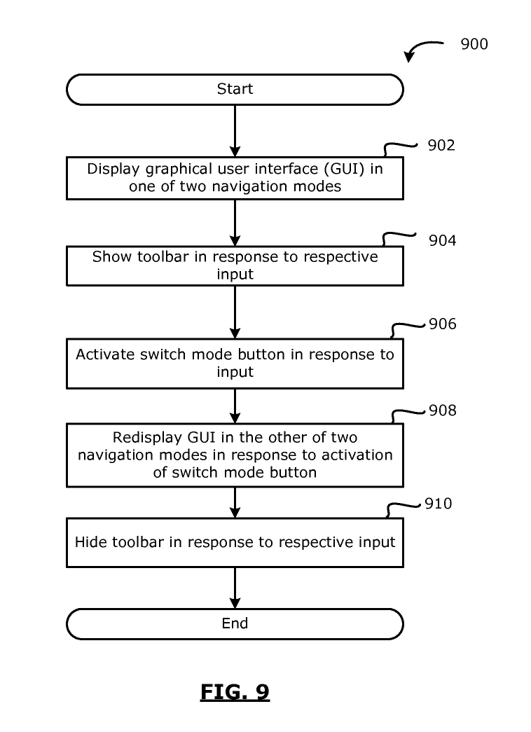

Referring now to FIGS. 6B and 8, a cursor navigation mode of the GUI of the device 201 in accordance with one example embodiment of the present disclosure will now be described. FIG. 6B illustrates a screen shot of a user interface screen 652 of a cursor navigation mode of the Web browser application in a portrait screen orientation; however, the cursor navigation mode could be used in other user interface screens of this application and other applications and menus of the GUI. The appearance of the GUI of the cursor navigation mode is similar to the pan navigation mode, with the notable exception that it provides an onscreen position navigational indicator 632 also referred to as a caret or cursor. Navigation within the cursor navigation mode differs from that within the pan navigation mode, as described below.

The illustrated navigational indicator 632 is an arrow; however, other shapes/symbols may be used. Moreover, the appearance of the navigational indicator 632 may be context-sensitive, changing based on the actions which are possible depending on the user interface element at the location on the touchscreen display 210.

As noted above, the switch mode button 626 of the toolbar 620 is context-sensitive. That is, selection of the switch mode button 626 in the cursor navigation mode changes the navigation mode to the pan navigation mode. As shown in FIG. 6B, in some embodiments of the GUI of the cursor navigation mode, visual indicia is displayed within the switch mode button 626 to provide a visual representation that the function of the button is to change the navigation mode to the pan navigation mode. This allows the device user to more easily identify the function associated with the virtual button and more quickly select the virtual button to switch between navigation modes. The visual indicia for the switch mode button 626 may be text such as “Pan Mode”, “Pan Navigation Mode” or “Cursor . . . ”, or an icon or other pictorial representation which is identifiable by the device user.

In the cursor navigation mode, the single-tap, double-tap and touch events operate in the same manner as described above in connection with the pan navigation mode; however, touch-and-drag events and swipe events are not recognized. Instead, navigation is provided by moving the navigational indicator 632 about the GUI.

Once in the cursor navigation mode, when a touch event is detected on the touchscreen display 210, the navigational indicator 632 automatically moves (“jumps”) to the corresponding location on the touchscreen display 210. “Jumping” to the touchpoint is advantageous in that it allows faster (re)positioning of the navigational indicator 632 to the location of a new touch event instead of requiring the user to “move” the navigational indicator 632 from its previous location to the location of the touch event as with conventional pointing devices. In contrast, in the pan navigation mode “jumping” does not occur as there is no navigational indicator 632 to move.

The navigational indicator 632 can be moved freely in any two-dimensional direction (e.g. up, down, left, right, diagonally, etc.) by touching the touchscreen display 210 with a finger and moving it around while maintaining contact with the touchscreen display 210. When the cursor navigation mode is initiated or switched to, the navigational indicator 632 is typically displayed at a default location such as the centre of the display area 608 or the center of the touchscreen display 210. The navigational indicator 632 tracks the touchpoint of the user's finger within the area 608 of the boundary 610 as the user's finger is moved; however, the navigational indicator 632 cannot move beyond the boundary 610. When the user's finger moves beyond the boundary 610, the navigational indicator 632 is locked at the respective border, typically at the location where the finger moved beyond the navigational boundary 610.

In the shown embodiment of FIG. 6B, the top border 601 of the boundary 610 is defined by the status bar 602, the bottom border 604 is defined by the horizontal scrollbar 614, the left border 605 is defined by the left-hand side of the display area 608, and the right border 607 is bounded by the vertical scrollbar 612. When the user's finger is moved beyond the top border 601, this causes the page in the display area 608 to scroll upwards when there is additional content above the currently displayed content available for display. When the user's finger is moved beyond the bottom border 604, this causes the page in the display area 608 to scroll downwards when there is additional content below the currently displayed content available for display. Similarly, when the user's finger is moved beyond the left border 605 of the boundary 610, this causes the page in the display area 608 to scroll left when there is additional content left of the currently displayed content available for display. When the user's finger is moved beyond the right border 607 of the boundary 610, this causes the page in the display area 608 to scroll right there is additional content right of the currently displayed content available for display.

It will be appreciated that in the cursor navigation mode content is scrolled in the same direction as finger movement and movement of the touchpoint. This can be contrasted with the pan navigation mode where content is scrolled occurs in the direction opposite to the direction of finger movement and movement of the touchpoint.

In other embodiments, the boundary 610 may be defined by other reference points of the GUI so that the navigational indicator 632 can be moved outside of the display area 608, for example, to interact with the status bar 602, vertical scrollbar 612 and/or horizontal scrollbar 614. In such embodiments, the boundary 610 could be defined by the entire displayable area of the touchscreen display 210, or other user interface elements of the GUI within the displayable area of the touchscreen display 210. In some embodiments, the scrolling may have a speed which is dependent on the distance of the new touchpoint from the boundary 610. The speed of scrolling may increase with the distance of the new touchpoint from the boundary 610.

In some embodiments, a “scrolling boundary” is defined within a “content boundary” represented by the boundary 610. The GUI, e.g. the Web browser user interface, scrolls content in accordance with cursor navigation mode described above when the navigational indicator 632 (e.g. cursor) is anywhere outside the “scrolling boundary”. However, the scrolling does not occur inside the area defined by the scrolling boundary. Outside of the scrolling boundary, the GUI could scroll the content at a constant rate regardless of where the navigational indicator 632 is between those two boundaries, or the GUI could scroll the content at variable speeds in proportion to the distance of the navigational indicator 632 is from the scrolling boundary.

Referring now to FIG. 8, an example process 800 of the cursor navigation mode in accordance with one example embodiment of the present disclosure will now be described. As shown in FIG. 6B, the GUI has a boundary 610 which defines an area 608 in which scrollable content such as a menu, Web page or other content page is displayed. The GUI includes a navigational indicator 632.

In a first step 802, a touch event is detected within the area 608 defined by the boundary 610 in response to the user touching the touchscreen display 210. The touchpoint of the touch event is defined in terms of an x and y location or other two-dimensional coordinates returned from the touchscreen display 210. The x and y location of the touch event are compared to the coordinates of the boundary 610. The process 800 continues only when the x and y location of the touch event are within the boundary 610.

Next, in step 804 it is determined whether there is a change in the touchpoint of the touch event. The x and y location of touch is determined and compared to the first determined x and y location from step 802, and any change in the x and y location is determined. If there is no change in the x and y location of the touch event, or a change that is below a predetermined threshold, no change in the touchpoint of the touch event is detected. If there is a change in the x and y location of the touch event, or a change that is greater than a predetermined threshold, a change in the touchpoint of the touch event is detected.

If the touchpoint has not changed (step 804), processing proceeds to step 806 where it is determined whether the touch event has ended. The touch event ends when contact with the touchscreen display is broken (e.g., the user lifts their finger or pointing device from the input surface of the touchscreen display 210). In the shown embodiment, the user interface element that corresponds to the x and y location of the touch event prior to the end of the touch event is selected (808). The selection could be the same user interface element, for example, if the touchpoint did not move between the starting and ending of the touch event. Alternatively, in other embodiments the process 800 ends when the touch event has ended.

When the touch event has not ended, the process 800 returns to step 804 where it is again determined if the touchpoint of touch event has changed. The touchpoint is then monitored to determine any changes during the touch event.

Referring again to step 804, when the touchpoint has changed, the direction of the change in the touchpoint relative to the screen orientation of the GUI is then determined based on the x and y location determined at step 802 and the new x and y location of touch event (step 810). The distance of the touchpoint from the

Next, it is determined whether the touchpoint has moved from a location within the area 608 defined by the boundary 610 to a new location outside of the area defined by the boundary 610 (step 812). This is performed based on the x and y values of the location of touch event after the change in location of the touch point. If the new location of touch event is inside the boundary 610, the navigational indicator 632 is moved to the new location (step 814). As noted above, the navigational indicator 632 tracks the touch event caused by the user.

When the touchpoint has moved from a location within the area 608 defined by the boundary 610 to a new location outside of the area 608 defined by the boundary 610, the distance from the boundary 610 is determined by determining the distance from the boundary 610 to the location of touch event based on the x and y values (step 816). This step is optional and need not be performed in all embodiments.

Next, in step 818 the content displayed within the area 608 defined by the boundary 610 is also then scrolled in accordance with a direction of the change in the location of the touchpoint when additional content is available. The navigational indicator 632 is also moved to the location on the touchscreen display 210 where the touchpoint moved outside the boundary 610. It is understood that the additional content must be available in the direction of scrolling, which in the cursor navigation mode, is the direction of movement of the touchpoint.

As will be appreciated by persons skilled in the art, scrolling the content displayed within the area 608 requires rendering the respective content and displaying the newly rendered content by the UI module 282 or other module 221, possibly along with the remainder of the user interface screen 752. Scrolling content in the cursor navigation mode comprises: scrolling upward on the page in response to movement of the touchpoint to a new location beyond a top border of the boundary 610; scrolling downward on the page in response to movement of the touchpoint to a new location beyond a bottom border of the boundary 610; scrolling leftward on the page in response to movement of the touchpoint to a new location beyond a left border of the boundary 610; and scrolling rightward on the page in response to movement of the touchpoint to a new location beyond a right border of the boundary 610.

The scrolling may have a speed which is dependent on the distance of the new touchpoint from the boundary 610 determined in optional step 814 in some embodiments. The speed of scrolling may increase with the distance of the new touchpoint from the boundary 610.

Next, in step 820 it is determined if there is another change in the location of touch event. The x and y location of the touch event is again determined and compared to the previous x and y location values and any change in the x and y location is determined. If there is a change in location of the touch event, the process 800 returns to step 810 where the direction of change is determined based on the x and y location previously determined.

Next, the process 800 proceeds to step 822 where it is again determined if the touch event has ended. If the touch event has not ended, the process returns to step 804 where it is again determined if the touchpoint of the touch event has changed. In the shown embodiment, the user interface element that corresponds to the x and y location of the touch event prior to the end of the touch event is selected (808). The selection could be the same user interface element, for example, if the touchpoint did not move between the starting and ending of the touch event. Alternatively, in other embodiments the process 800 ends when the touch event has ended.

In some embodiments, the scrolling in step 818 may be delayed by a delay time to prevent inadvertent scrolling. The delay time could be predetermined or could be determined based on the distance from the boundary 610 determined at step 814. For example, the distance from the boundary 610 could determine the delay time for rendering the scrolled screen such that a shorter delay time results from movement of the touchpoint to a location farther from the boundary 610. In some embodiments, the scrolling could be automatically performed after the delay time has lapsed. Alternatively, the duration of time that the touchpoint is outside the boundary 610 may need to exceed the delay time before scrolling. In some embodiments, step 818 could start a countdown timer on its first processing rather than scrolling the content immediately. During subsequent loops from step 822, the value of the countdown timer could be evaluated to determine the countdown timer has expired. When the countdown timer expires, the scrolling could be automatically performed.

It will be appreciated that the process shown and described with reference to FIG. 8 is simplified for the purpose of the present explanation and other steps and substeps may be included. Alternatively, some of the steps and substeps may be excluded.

It will be appreciated that the foregoing paragraphs describe GUI navigation (i.e., page scrolling action) in relation to the touchpoint of the touch event caused by the user's finger. That is, the touchpoint of the user's finger has to move beyond the top, bottom, left or right border of the boundary 610 to cause page scrolling in the respective direction. However, the cursor navigation mode could also be described in the context of the location of the navigational indicator 632 because the navigational indicator 632 tracks finger movement to provide a visual indication or cue to the user as to their touchpoint. In other embodiments, the touchpoint and the location of the navigational indicator 632 may be different though similar, for example, when a touch offset is used by the GUI. As will be appreciated by persons skilled in the art, touch offsets may be used to offset the navigational indicator 632 from the touchpoint of the user's finger to accommodate the tendency of device users to press below target items to avoid covering them. In such embodiments, cursor navigation could be based on the touchpoint or the location of the navigational indicator 632 (which is the touch point adjusted by a predetermined value).

### Switching Navigation Modes

Reference is now made to FIG. 9 which illustrates an example process 900 for switching between navigational modes on the touchscreen display 210 of the mobile communication device 201 in accordance with one embodiment of the present disclosure. The process 900 is carried out by the processor 240 of the mobile communication device 201 under the instruction of software modules 221 such as one or a combination of the user interface module 282, cursor navigation module 286, pan navigation module 288 or the Web browser module 284. That is, the process 900 of FIG. 9 is carried out by routines or subroutines of software executed by the processor 240. The coding of software for carrying out the described method is well within the scope of a person of ordinary skill in the art having regard to the present disclosure.

In the first step 902, a GUI is rendered and displayed on the display screen 204 of the touchscreen display 210. The GUI includes a user interface screen having a display area 608 defined by a boundary 610 as shown in FIGS. 6A and 6B. The GUI could be provided in response to input received by the processor 240 to switch to a particular operational mode or application 225 on the device 201 which supports a dual mode GUI having both a pan navigation mode and a cursor navigation mode for controlling the device 201, and which supports switching between these navigation modes. The GUI is initially displayed in one of the pan navigation mode or cursor navigation mode. The navigation mode in which the GUI is first displayed may depend on the current operational mode or application 225 and could be configurable. Once within the pan navigation mode or cursor navigation mode, the display area 608 may be navigated using the respective navigation mode as described above.

In some embodiments, the GUI is that of the Web browser application provided by the Web browser module 284; however, other applications 225 could utilize the navigational modes and method of switching between navigation modes described herein. When other applications use the described navigational modes and method of switching, the display area 608 may be used to display menus, content pages other than web pages or other suitable content.

Next, in step 906 input is received by the processor 240 to switch the navigation mode of the device 201 from one of the pan navigation mode and cursor navigation mode, to the other of the pan navigation mode and cursor navigation mode. The input is typically received by selection and/or activation of the switch mode button 626 in the toolbar 620; however, in other embodiments the input may be received via another input device or user interface element. For example, in some embodiments, rather than using a virtual button in the toolbar 620 to switch between navigational modes, one of the control buttons 260 may be associated with the switch function when the active operational mode or application 225 on the device 201 supports switching between navigational modes. Alternatively, a specialized key (e.g. hot key) or predetermined key combination of a mechanical keyboard provided by the device 201 may be used to switch between navigational modes.

In embodiments in which the input to switch the navigation mode of the device 201 is the activation of the switch mode button 626 in the toolbar 620, an optional step 904 of showing/displaying the toolbar 620 may be performed prior to step 906 when it is not currently displayed on the touchscreen display 210. In some embodiments, the toolbar 620 may be shown/displayed on the touchscreen display 210 by performing a single-tap on the touchscreen display 210. The switch mode button 626 can be selected by touching the corresponding location on the touchscreen display 210 and then clicking or depressing the touchscreen display 210 to activate the switch 261. In some embodiments, the switch mode button 626 may be activated by clicking the touchscreen display 210 at the location of the switch mode button 626 without first selecting it.

Next, in step 908 the GUI is re-rendered and re-displayed on the display screen 204 in the other of the pan navigation mode and cursor navigation mode in response to the received input such as, for example, the activation of the switch mode button 626. Once within the pan navigation mode or cursor navigation mode, the display area 608 may be navigated using the respective navigation mode as described above.

In embodiments in which the input to switch the navigation mode of the device 201 is the activation of the switch mode button 626 in the toolbar 620, an optional step 910 of hidden the toolbar 620 may be performed when it is displayed on the touchscreen display 210. In some embodiments, the toolbar 620 may be hidden by performing a single-tap on the touchscreen display 210

While the process 900 has been described as occurring in a particular order, it will be appreciated to persons skilled in the art that some of the steps may be performed in a different order provided that the result of the changed order of any given step will not prevent or impair the occurrence of subsequent steps. Furthermore, some of the steps described above may be combined in other embodiments, and some of the steps described above may be separated into a number of sub-steps in other embodiments.

It will be appreciated that the cursor navigation mode of the present disclosure provides a navigation mechanism in which the position of the cursor or other onscreen position indicator can be precisely controlled and moved to particular locations on the display screen 204, for example, in order to select and/or activate a user interface element at that location, or perform another function, command or process at that location.

The pan navigation mode of the present disclosure provides a navigation mechanism in which the user can touch a location on the touchscreen display 210 which virtually connects to the corresponding location on an underlying page of content represented on the display screen 204. When the user drags their finger in any direction, the content scrolls accordingly so that the location on the content page where the user initially touched remains under the user's fingertip as the user moves their finger around the touchscreen display 210. Such a pan navigation mode provides a very intuitive way to scroll content around the display screen 204, but suffers from the inability to precisely position the touchpoint because it defined by the area under the user's fingertip, and the location on the page that the user is trying to select or focus is occluded by the user's finger, preventing visual feedback for fine-grained control.

The provision of both pan and cursor navigation modes on a mobile communication device 201 and a mechanism for switching between them allows users to select the most appropriate navigation mechanism in the circumstances. The mechanism for selecting the navigation mode which provided by the present disclosure may reduce the amount of device processing required by reducing the number of navigation and selection inputs required to accomplish a particular task or action. This may in turn reduce the amount of graphics (re)rendering required. The switch mode button 626 of the toolbar 620 described herein provides a relatively simple and intuitive mechanism for switching between navigation modes which not only simplifies the switch process but reduces the necessary processing steps over conventional approaches using hierarchical menu structures, thereby reducing the demand on device resources.

### Communication System

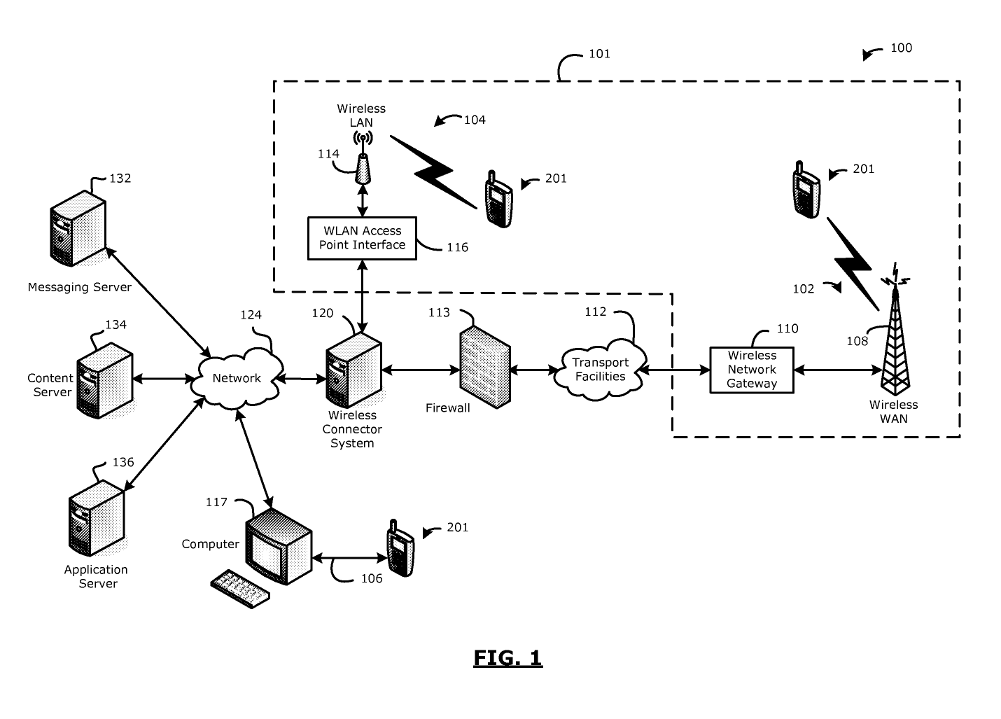

In order to facilitate an understanding of one possible environment in which example embodiments described herein can operate, reference is made to FIG. 1 which shows in block diagram form a communication system 100 in which example embodiments of the present disclosure can be applied. The communication system 100 comprises a number of mobile communication devices 201 which may be connected to the remainder of system 100 in any of several different ways. Accordingly, several instances of mobile communication devices 201 are depicted in FIG. 1 employing different example ways of connecting to system 100. Mobile communication devices 201 are connected to a wireless network 101 which may comprise one or more of a Wireless Wide Area Network (WWAN) 201 and a Wireless Local Area Network (WLAN) 104 or other suitable network arrangements. In some embodiments, the mobile communication devices 201 are configured to communicate over both the WWAN 201 and WLAN 104, and to roam between these networks. In some embodiments, the wireless network 101 may comprise multiple WWANs 201 and WLANs 104.

The WWAN 201 may be implemented as any suitable wireless access network technology. By way of example, but not limitation, the WWAN 201 may be implemented as a wireless network that includes a number of transceiver base stations 108 (one of which is shown in FIG. 1) where each of the base stations 108 provides wireless Radio Frequency (RF) coverage to a corresponding area or cell. The WWAN 201 is typically operated by a mobile network service provider that provides subscription packages to users of the mobile communication devices 201. In some embodiments, the WWAN 201 conforms to one or more of the following wireless network types: Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) CDMA2000, EDGE (Enhanced Data rates for GSM Evolution), UMTS (Universal Mobile Telecommunication Systems), HSPDA (High-Speed Downlink Packet Access), IEEE 802.16e (also referred to as Worldwide Interoperability for Microwave Access or “WiMAX), or various other networks. Although WWAN 201 is described as a “Wide-Area” network, that term is intended herein also to incorporate wireless Metropolitan Area Networks (WMAN) and other similar technologies for providing coordinated service wirelessly over an area larger than that covered by typical WLANs.

The WWAN 201 may further comprise a wireless network gateway 110 which connects the mobile communication devices 201 to transport facilities 112, and through the transport facilities 112 to a wireless connector system 120. Transport facilities may include one or more private networks or lines, the public Internet, a virtual private network, or any other suitable network. The wireless connector system 120 may be operated, for example, by an organization or enterprise such as a corporation, university, or governmental department, which allows access to a network 124 such as an internal or enterprise network and its resources, or the wireless connector system 120 may be operated by a mobile network provider. In some embodiments, the network 124 may be realised using the Internet rather than an internal or enterprise network.

The wireless network gateway 110 provides an interface between the wireless connector system 120 and the WWAN 201, which facilitates communication between the mobile communication devices 201 and other devices (not shown) connected, directly or indirectly, to the WWAN 201. Accordingly, communications sent via the mobile communication devices 201 are transported via the WWAN 201 and the wireless network gateway 110 through transport facilities 112 to the wireless connector system 120. Communications sent from the wireless connector system 120 are received by the wireless network gateway 110 and transported via the WWAN 201 to the mobile communication devices 201.

The WLAN 104 comprises a wireless network which, in some embodiments, conforms to IEEE 802.11x standards (sometimes referred to as Wi-Fi) such as, for example, the IEEE 802.11a, 802.11b and/or 802.11g standard. Other communication protocols may be used for the WLAN 104 in other embodiments such as, for example, IEEE 802.11n, IEEE 802.16e (also referred to as Worldwide Interoperability for Microwave Access or “WiMAX”), or IEEE 802.20 (also referred to as Mobile Wireless Broadband Access). The WLAN 104 includes one or more wireless RF Access Points (AP) 114 (one of which is shown in FIG. 1) that collectively provide a WLAN coverage area.

The WLAN 104 may be a personal network of the user, an enterprise network, or a hotspot offered by an Internet service provider (ISP), a mobile network provider, or a property owner in a public or semi-public area, for example. The access points 114 are connected to an access point (AP) interface 116 which may connect to the wireless connector system 120 directly (for example, if the access point 114 is part of an enterprise WLAN 104 in which the wireless connector system 120 resides), or indirectly as indicated by the dashed line if FIG. 1 via the transport facilities 112 if the access point 14 is a personal Wi-Fi network or Wi-Fi hotspot (in which case a mechanism for securely connecting to the wireless connector system 120, such as a virtual private network (VPN), may be required). The AP interface 116 provides translation and routing services between the access points 114 and the wireless connector system 120 to facilitate communication, directly or indirectly, with the wireless connector system 120.

The wireless connector system 120 may be implemented as one or more servers, and is typically located behind a firewall 113. The wireless connector system 120 manages communications, including email communications, to and from a set of managed mobile communication devices 201. The wireless connector system 120 also provides administrative control and management capabilities over users and mobile communication devices 201 which may connect to the wireless connector system 120.

The wireless connector system 120 allows the mobile communication devices 201 to access the network 124 and connected resources and services such as a messaging server 132 (for example, a Microsoft Exchange™, IBM Lotus Domino™, or Novell GroupWise™ email server), and a content server 134 for providing content such as Internet content or content from an organization's internal servers, and application servers 136 for implementing server-based applications such as instant messaging (IM) applications to mobile communication devices 201.

The wireless connector system 120 typically provides a secure exchange of data (e.g., email messages, personal information manager (PIM) data, and IM data) with the mobile communication devices 201. In some embodiments, communications between the wireless connector system 120 and the mobile communication devices 201 are encrypted. In some embodiments, communications are encrypted using a symmetric encryption key implemented using Advanced Encryption Standard (AES) or Triple Data Encryption Standard (Triple DES) encryption. Private encryption keys are generated in a secure, two-way authenticated environment and are used for both encryption and decryption of data. In some embodiments, the private encryption key is stored only in the user's mailbox on the messaging server 132 and on the mobile communication device 201, and can typically be regenerated by the user on mobile communication devices 201. Data sent to the mobile communication devices 201 is encrypted by the wireless connector system 120 using the private encryption key retrieved from the user's mailbox. The encrypted data, when received on the mobile communication devices 201, is decrypted using the private encryption key stored in memory. Similarly, data sent to the wireless connector system 120 from the mobile communication devices 201 is encrypted using the private encryption key stored in the memory of the mobile communication device 201. The encrypted data, when received on the wireless connector system 120, is decrypted using the private encryption key retrieved from the user's mailbox.

The wireless network gateway 110 is adapted to send data packets received from the mobile communication device 201 over the WWAN 201 to the wireless connector system 120. The wireless connector system 120 then sends the data packets to the appropriate connection point such as the messaging server 132, content server 134 or application servers 136. Conversely, the wireless connector system 120 sends data packets received, for example, from the messaging server 132, content server 134 or application servers 136 to the wireless network gateway 110 which then transmit the data packets to the destination mobile communication device 201. The AP interfaces 116 of the WLAN 104 provide similar sending functions between the mobile communication device 201, the wireless connector system 120 and network connection point such as the messaging server 132, content server 134 and application server 136.

The network 124 may comprise a private local area network, metropolitan area network, wide area network, the public Internet or combinations thereof and may include virtual networks constructed using any of these, alone, or in combination.

A mobile communication device 201 may alternatively connect to the wireless connector system 120 using a computer 117, such as desktop or notebook computer, via the network 124. A link 106 may be provided for exchanging information between the mobile communication device 201 and computer 117 connected to the wireless connector system 120. The link 106 may comprise one or both of a physical interface and short-range wireless communication interface. The physical interface may comprise one or combinations of an Ethernet connection, Universal Serial Bus (USB) connection, Firewire™ (also known as an IEEE 1394 interface) connection, or other serial data connection, via respective ports or interfaces of the mobile communication device 201 and computer 117. The short-range wireless communication interface may be a personal area network (PAN) interface. A personal area network is a wireless point-to-point connection meaning no physical cables are required to connect the two end points. The short-range wireless communication interface may comprise one or a combination of an infrared (IR) connection such as an Infrared Data Association (IrDA) connection, a short-range radio frequency (RF) connection such as one specified by IEEE 802.15.1 or the Bluetooth™ special interest group, or IEEE 802.15.3a, also referred to as UltraWideband (UWB), or other PAN connection.

It will be appreciated that the above-described communication system is provided for the purpose of illustration only, and that the above-described communication system comprises one possible communication network configuration of a multitude of possible configurations for use with the mobile communication devices 201. The teachings of the present disclosure may be employed in connection with any other type of network and associated devices that are effective in implementing or facilitating wireless communication. Suitable variations of the communication system will be understood to a person of skill in the art and are intended to fall within the scope of the present disclosure.

While the present disclosure is primarily described in terms of methods, a person of ordinary skill in the art will understand that the present disclosure is also directed to various apparatus such as a handheld electronic device including components for performing at least some of the aspects and features of the described methods, be it by way of hardware components, software or any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the described methods. It is understood that such apparatus, articles of manufacture, and computer data signals also come within the scope of the present disclosure.

The term “computer readable medium” as used herein means any medium which can store instructions for use by or execution by a computer or other computing device including, but not limited to, a portable computer diskette, a hard disk drive (HDD), a random access memory (RAM), a read-only memory (ROM), an erasable programmable-read-only memory (EPROM) or flash memory, an optical disc such as a Compact Disc (CD), Digital Versatile Disc (DVD) or Blu-ray™ Disc, and a solid state storage device (e.g., NAND flash or synchronous dynamic RAM (SDRAM)).

The various embodiments presented above are merely examples and are in no way meant to limit the scope of this disclosure. Variations of the innovations described herein will be apparent to persons of ordinary skill in the art, such variations being within the intended scope of the present application. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A handheld electronic device, comprising:
a controller;
a touchscreen display connected to the controller;
the controller being configured for displaying on the touchscreen display a graphical user interface (GUI) having an area defined by a boundary for displaying content;
the controller, in a pan navigation mode, being configured for: detecting touch events having a touchpoint on the touchscreen display; determining when the touchpoint of a touch event has changed; determining a change in the location of the touchpoint relative to the screen orientation of the GUI; and scrolling the content in the area defined by the boundary in accordance with the change in location of the touchpoint;
the controller, in a cursor navigation mode, being configured for: detecting touch events having a touchpoint on the touchscreen display; determining when the touchpoint of a touch event has changed; determining a change in the location of the touchpoint relative to the screen orientation of the GUI; and scrolling the content in the area defined by the boundary in accordance with the change in location of the touchpoint when the touchpoint has moved from a location within the area defined by the boundary to a new location outside of the area defined by the boundary;
the controller being configured for switch between the pan navigation mode and the cursor navigation mode in response to respective input.

2. The device of claim 1, wherein the controller in the cursor navigation mode is configured for displaying a navigational indicator in the GUI and moving the navigational indicator in accordance with changes in the touchpoint of touch events.

3. The device of claim 1, wherein the controller in both the pan navigation mode and the cursor navigation mode determines that the touchpoint of a touch event has changed when two-dimensional coordinates defining the touchpoint of the touch event have changed by more than a predetermined threshold.

4. The device of claim 1, wherein the scrolling in the pan navigation mode comprises: scrolling upward on the page in response to a downward change in the touchpoint; and scrolling downward on the page in response to an upward change in the touchpoint.

5. The device of claim 4, wherein the scrolling in the pan navigation mode comprises: scrolling leftward on the page in response to a rightward change in the touchpoint; and scrolling rightward on the page in response to leftward change in the touchpoint.

6. The device of claim 1, wherein the scrolling in the cursor navigation mode comprises: scrolling upward on the page in response to movement of the touchpoint to a new location outside a top border of the boundary; scrolling downward on the page in response to movement of the touchpoint to a new location outside a bottom border of the boundary.

7. The device of claim 6, wherein the scrolling in the cursor navigation mode comprises: scrolling leftward on the page in response to movement of the touchpoint to a new location outside a left border of the boundary; and scrolling rightward on the page in response to movement of the touchpoint to a new location outside a right border of the boundary.

8. The device of claim 1, wherein the scrolling has a speed which is dependent on a distance of the new touchpoint from the boundary.

9. The device of claim 8, wherein the speed increases with distance of the new touchpoint from the boundary.

10. The device of claim 1, wherein the controller in both the pan navigation mode and the cursor navigation mode is configured for displaying or hiding a toolbar having a plurality of virtual buttons in response to respective input, one of the virtual buttons being a context-sensitive switch mode button for switching between the cursor navigation mode and pan navigation mode, wherein activating the switch mode button in the cursor navigation mode changes the navigation mode to the pan navigation mode, and wherein activating the switch mode button in the pan navigation mode changes the navigation mode to the cursor navigation mode.

11. The device of claim 10, wherein the respective input is a tap such that the toolbar is displayed in response to a tap when the toolbar is not displayed on the touchscreen display, and the toolbar is hidden in response to a tap when the toolbar is displayed on the touchscreen display.

12. The device of claim 10, wherein the toolbar is located at the bottom of the GUI and the switch mode button is centrally located within the toolbar.

13. The device of claim 10, wherein the controller is configured for displaying the toolbar with the GUI when initially displayed on the touchscreen display.

14. The device of claim 1, further comprising one or more control buttons connected to the controller, wherein the input to switch between the cursor navigation mode and pan navigation mode is activation of a particular one of the control buttons.

15. The device of claim 1, further comprising a keyboard comprising a plurality of keys connected to the controller, wherein the input to switch between the cursor navigation mode and pan navigation mode is activation of a dedicated key or predetermined key combination.

16. A method of controlling a handheld electronic device comprising a touchscreen display, the method comprising:
providing on the touchscreen display a graphical user interface (GUI) having an area defined by a boundary for displaying content, the GUI having a cursor navigation mode and a pan navigation mode;
in the pan navigation mode: detecting touch events having a touchpoint on the touchscreen display; determining when the touchpoint of a touch event has changed; determining a change in location of the touchpoint relative to the screen orientation of the GUI; and scrolling the content in the area defined by the boundary in accordance with the change in location of the touchpoint;
in a cursor navigation mode: detecting touch events having a touchpoint on the touchscreen display; determining when the touchpoint of a touch event has changed; determining a change in location of the touchpoint relative to the screen orientation of the GUI; and scrolling the content in the area defined by the boundary in accordance with the change in location of the touchpoint when the touchpoint has moved from a location within the area defined by the boundary to a new location outside of the area defined by the boundary; and
switching between the pan navigation mode and cursor navigation mode in response to respective input.

17. The method of claim 16, further comprising:
in the cursor navigation mode, displaying a navigational indicator in the GUI and moving the navigational indicator in accordance with changes in the touchpoint of touch events.

18. The method of claim 16, wherein the scrolling in the pan navigation mode comprises: scrolling upward on the page in response to a downward change in the touchpoint; scrolling downward on the page in response to an upward change in the touchpoint; scrolling leftward on the page in response to a rightward change in the touchpoint; and scrolling rightward on the page in response to leftward change in the touchpoint.

19. The method of claim 16, wherein the scrolling in the cursor navigation mode comprises: scrolling upward on the page in response to movement of the touchpoint to a new location outside a top border of the boundary; scrolling downward on the page in response to movement of the touchpoint to a new location outside a bottom border of the boundary; scrolling leftward on the page in response to movement of the touchpoint to a new location outside a left border of the boundary; and scrolling rightward on the page in response to movement of the touchpoint to a new location outside a right border of the boundary.

20. The method of claim 16, further comprising:
displaying or hiding a toolbar having a plurality of virtual buttons in response to respective input, one of the virtual buttons being a context-sensitive switch mode button for switching between the cursor navigation mode and pan navigation mode, wherein activating the switch mode button in the cursor navigation mode changes the navigation mode to the pan navigation mode, and wherein activating the switch mode button in the pan navigation mode changes the navigation mode to the cursor navigation mode.
